(19) United States
(12) Patent Application Publication
(10) Pub. No.: US 2017/0045105 A1
(43) Pub. Date: Feb. 16, 2017

(54) Electric Brake Caliper

(71) Applicant: Persimmon Technologies, Corp., Wakefield, MA (US)

(72) Inventors: Christopher Hofmeister, Hampstead, NH (US); Martin Hosek, Lowell, MA (US)

(21) Appl. No.: 15/228,501

(22) Filed: Aug. 4, 2016

Related U.S. Application Data
(60) Provisional application No. 62/218,633, filed on Sep. 15, 2015.
(60) Provisional application No. 62/200,826, filed on Aug. 4, 2015.

(51) Int. Cl. F16D 65/18; F16D 55/225

(52) U.S. Cl. CPC F16D 65/18; F16D 55/225; F16D 2055/0091

(57) ABSTRACT

A brake caliper includes a housing and a hydraulic actuator connected to the housing. The hydraulic actuator includes a hydraulic cylinder connected to the housing, a lining piston movably mounted with the hydraulic cylinder, and an electric actuator. The electric actuator includes an electric motor and a working piston. The electric actuator is configured to move the working piston such that the working piston pushes against the hydraulic fluid in the hydraulic actuator.

### CROSS REFERENCE TO RELATED APPLICATIONS

This application claims priority to U.S. provisional application No. 62/200,826 filed Aug. 4, 2015 and U.S. provisional application No. 62/218,633 filed Sep. 15, 2015, both of which are hereby incorporated by reference in their entireties.

### BACKGROUND

Technical Field

The exemplary and non-limiting embodiments relate generally to a brake caliper and, more particularly, to a hybrid electric brake caliper.

Brief Description of Prior Developments

Brake calipers may be used in automotive or suitable applications where the caliper is utilized on a disk or rotor that is coupled to a wheel or other rotating device to have a braking force applied. The most common calipers are foot actuated by an operator where pressing a brake pedal energizes a power assisted master cylinder that distributes pressurized fluid to multiple calipers on a given vehicle where the calipers have slave cylinders that are actuated by the pressurized fluid to apply force to opposing brake pads on the brake rotor resulting in a braking force being applied to the rotor due to friction between the pads and the rotor.

### SUMMARY

The following summary is merely intended to be exemplary. The summary is not intended to limit the scope of the claims.

In accordance with one aspect, a brake caliper comprises a housing and a hydraulic actuator connected to the housing, where the hydraulic actuator comprises a hydraulic cylinder connected to the housing, a lining piston movably mounted with the hydraulic cylinder, and an electric actuator, where the electric actuator comprises an electric motor and a working piston, where the electric actuator is configured to move the working piston such that the working piston pushes against the hydraulic fluid in the hydraulic actuator.

In accordance with another aspect, a brake caliper comprises a housing and a hydraulic actuator connected to the housing, where the hydraulic actuator comprises a hydraulic cylinder connected to the housing, a lining piston movably mounted with the hydraulic cylinder, and an electric actuator, where the electric actuator comprises an electric motor and a working piston, where the motor comprises a stator and a rotor, where the working piston is connected to the rotor to push against the hydraulic fluid in the hydraulic actuator based upon the rotor being rotated by the stator.

In accordance with another aspect, an example apparatus comprises a brake caliper comprising a housing; opposing brake linings; a brake lining drive connected to the housing, where the brake lining drive comprises an electric motor and a rotatable screw shaft extending from the electric motor; and a mechanical connection of the rotatable screw shaft to at least one of the opposing brake linings, where the mechanical connection is configured to linearly move the at least one opposing brake lining based upon axial rotation of the rotatable screw shaft by the electric motor.

### BRIEF DESCRIPTION OF THE DRAWINGS

The foregoing aspects and other features are explained in the following description, taken in connection with the accompanying drawings, wherein:

FIG. 1 is a side schematic view of a brake caliper;

FIG. 2 is a partial section schematic view of a brake caliper;

FIG. 3 is a partial section schematic view of a brake caliper;

FIG. 4 is a partial section schematic view of a brake caliper;

FIG. 5 is a partial section schematic view of a brake caliper;

FIG. 6 is a partial section schematic view of a brake caliper;

FIG. 7A is schematic view of a brake caliper system;

FIG. 7B is a side schematic view of a brake caliper;

FIG. 8 is a top schematic view of a brake caliper;

FIG. 9 is a top schematic view of a brake caliper;

FIG. 10A is an end schematic view of a brake caliper;

FIG. 10B is a top schematic view of a brake caliper;

FIG. 11A is an end schematic view of a brake caliper;

FIG. 11B is a top schematic view of a brake caliper;

FIG. 12 is an isometric view of a brake caliper;

FIG. 13 is an isometric section view of a brake caliper;

FIG. 14 is an exploded isometric view of a brake caliper;

FIG. 15 is an isometric, view of a brake caliper;

FIG. 16 is an isometric section view of a brake caliper;

FIG. 17 is an exploded isometric view of a brake caliper;

FIG. 18 is schematic view of a brake caliper system;

FIG. 19 is schematic view of a brake caliper system;

FIG. 20 is schematic view of a brake caliper system;

FIG. 21 is schematic view of a brake caliper system;

FIG. 22 is schematic top view of a brake caliper;

FIG. 23 is schematic top view of a brake caliper;

FIG. 24 is a schematic block diagram illustrating an example embodiment;

FIG. 25 is a schematic block diagram illustrating an example embodiment;

FIG. 26 is a schematic block diagram illustrating an example embodiment; and

FIG. 27 is a schematic block diagram illustrating an example embodiment.

### DETAILED DESCRIPTION OF EMBODIMENTS

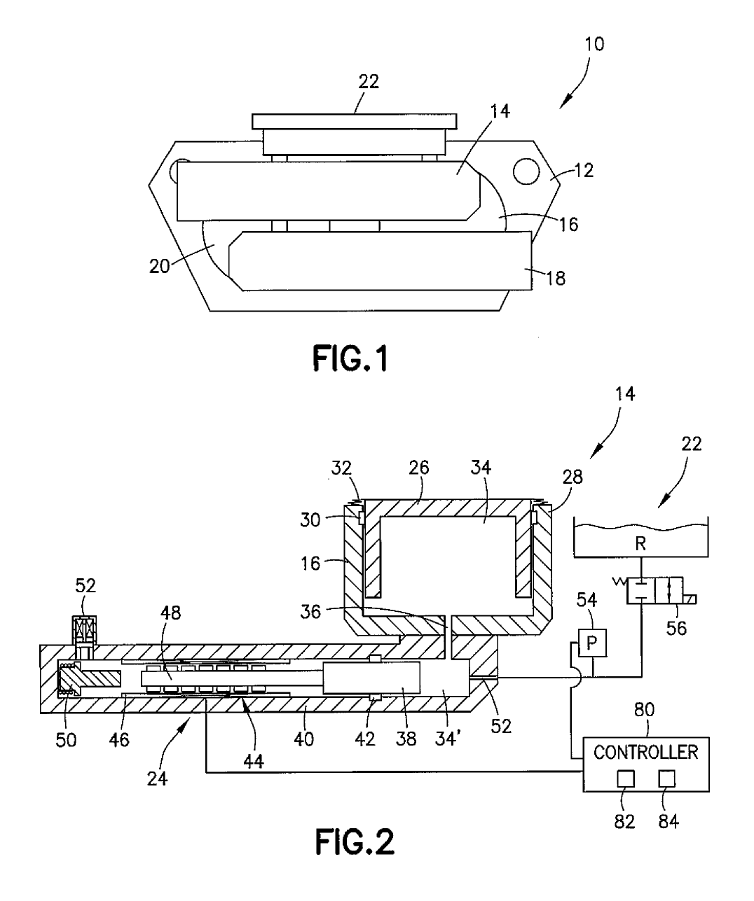

Referring to FIG. 1, there is shown a schematic side view of an example brake caliper 10 having a housing 12. Although the present invention will be described with reference to the embodiments shown in the drawings, it should be understood that the present invention may be embodied in many forms of alternative embodiments. In addition, any suitable size, shape or type of materials or elements could be used.

Alternate embodiments of hybrid hydraulic electric brake calipers and electromechanical brake calipers that may utilize hydraulic amplification with an electrically actuated working piston driving one or more lining pistons are disclosed. The caliper may be such that a self-contained unit may be deployed at each wheel of a vehicle or device to be braked without the use of distributed hydraulics. Here, each brake may be controlled autonomously and independently. The working piston(s) may be smaller in diameter than the lining piston(s). A brake fluid reservoir may replenish fluid in the caliper as the break lining wears. The brake fluid reservoir may be centralized and shared between the calipers or packaged locally at the actuator with a single reservoir per caliper. Alternate embodiments are disclosed that do not rely on hydraulics. The caliper may have a single lining piston or multiple lining pistons where the load may be spread more evenly across the brake pad wear surface. The caliper may have a single lining piston or multiple lining pistons on a single side of the rotor or alternately may have a single lining piston or multiple lining pistons on opposing sides of the rotor. Further disclosed are non-hydraulic calipers utilizing mechanical linkages and components and further utilizing magnetic fields. The embodiments may be provided with features alone or in combination with each other. Further, features as disclosed in United States Patent Application Publication US 2015/0136539 with a publication date of May 21, 2015; United States Patent Application Publication US 2015/0090540 with a publication date of Apr. 2, 2015; United States Patent Application Publication US 2014/0231189 with a publication date of Aug. 21, 2014; United States Patent Application Publication US 2013/0264154 with a publication date of Oct. 10, 2013; United States Patent Application Publication US 2011/0278107 with a publication date of Nov. 17, 2011 all of which are incorporated by reference herein may be provided alone or in combination with features disclosed. By way of example, features disclosed in the aforementioned patent publications may be utilized as a secondary or parking brake in combination with or as part of the calipers disclosed here in. By way of further example, features disclosed in the aforementioned patent publications such as gear trains or other power transmission components or otherwise may be utilized in place of components, for example, shafts or directly driven components of the calipers disclosed here in.

Referring to FIG. 1, there is shown a side schematic view of caliper 10. Caliper 10 has housing 12, first hydraulic actuator 14 having first lining cylinder 16, second hydraulic actuator 18 having second lining cylinder 20 and reservoir 22. Caliper 10 is shown having two independently driven lining cylinders for redundancy in the event of failure of one of them. Here, redundant working pistons and lining pistons are provided. Alternately, more or less lining cylinders may be provided. Referring also to FIG. 2, there is shown a section schematic view of first hydraulic actuator 14. First hydraulic actuator 14 has lining cylinder 16, electric actuator 24 and reservoir 22. Lining cylinder 16 has lining piston 26 in lining housing 28, seal 30, expansion seal 32, and pressurized fluid space 34 in communication with actuator 24 via port 36 between the two sealed housings 28, 40. In the embodiment shown, the windings and motor thermally isolated from the main caliper housing by a thermal break. Alternately, a single cast housing without ports may be provided. Alternately, actuator 14 may be thermally isolated from caliper housing or lining piston 20 with a thermal break such as a short brake line instead of port 36. Electric actuator 24 has working piston 38 in actuator cylinder housing 40 with working piston seal 42. Pressurized fluid space 34 also extends into the housing 40 at area 34′. The two housings 28 and 40 are sealingly connected to each other, or perhaps integrally formed with a one-piece member for example, or otherwise unitary. The housings 28, 40 form a unitary housing for both the lining piston 26 and the electric actuator 24. The working piston 38 may be spring biased (not shown) or may not be spring biased. Linear motor 44 has stator 46 and driven member 48. Linear motor 44 may be a commutated linear motor, for example, brushless or stepping type motor. Alternately a voice coil or linear actuator, for example, commutated, circular, rectangular or otherwise may be provided. Alternately, any suitable actuator, for example, a motor and screw combination may be provided, directly or indirectly coupled to the working piston. Position feedback (not shown) may be provided in any suitable manner for working piston 38. Reservoir 22 is coupled to cylinders 28, 40 via port 52 and has pressure switch 54 and valve 56 to replenish the caliper with brake fluid. Valve 56 may be selectively actuated, for example, electrically, or may be passive, for example, as a check valve or otherwise. Pressure feedback may be provided by pressure switch 54 in a manner where, for example, in an automotive application, four independent braking systems may be selectively controlled. In this example embodiment the valve 56, pressure switch 54 and electric motor 44 are connected to a controller 80. The controller 80 may comprise, for example, a processor 82 and a memory 84 comprising software for at least partially controlling the valve 56 and/or motor 44. The controller 80 may also be connected to the solenoid 52. Actuation of piston 38 with a smaller cross section than piston 26 drives piston 26. This actuation amplifies the load applied by motor 44 to the load applied by piston 26 to a brake lining in proportion to the respective areas. Spring actuated emergency plunger 50 and solenoid 52 are shown and may be provided such that loss of power on solenoid 52 releases a spring loaded catch releasing plunger 50 with a spring bias against working piston 38.

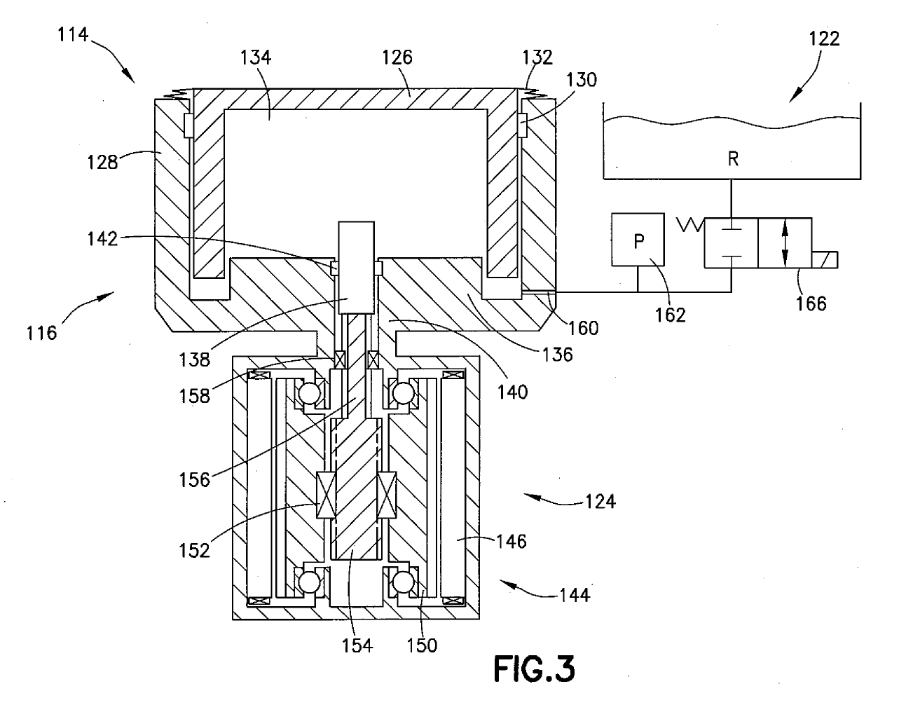

Referring now to FIG. 3, there is shown a section schematic view of electric-hydraulic actuator 114 for a caliper. Actuator 114 has lining cylinder 116, electric actuator 124, and reservoir 122. Lining cylinder 116 has lining piston 126 in lining housing 128, seal 130, expansion seal 132, pressurized fluid space 134 in communication with actuator 124 via interface portion 136. Electric actuator 124 has working piston 138 in actuator cylinder housing 140 and sealed 142. The working piston/cylinder is shown nested in the lining piston/cylinder. Bellows or other suitable piston may be provided instead of the piston shown. Motor 144 has stator 146 and rotor 150 with nut 152 coupled to rotor 150 and driving threaded shaft 154. Threaded shaft 154 is coupled to working piston 138 with splined shaft 156. Threaded shaft 154, working piston 138 and splined shaft 156 are constrained not to rotate by spline guide 158 coupled to housing 140. Reservoir 122 is coupled to cylinder 140 via port 160 and further has pressure switch 162 and valve 166. The 138 piston in this example is a translating working piston such that translation of piston 138 occurs if rotor 150 rotates. Threaded portion may be any suitable thread, for example, acme type thread or ball screw thread and may be locking such that the piston may not be back driven. Position feedback may be provided, for example for the rotor or working piston.

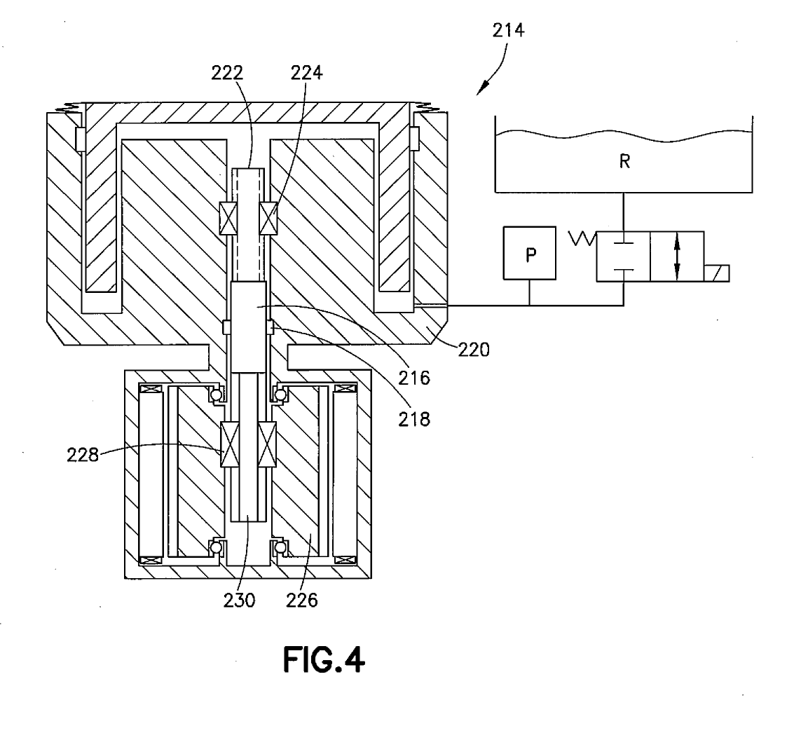

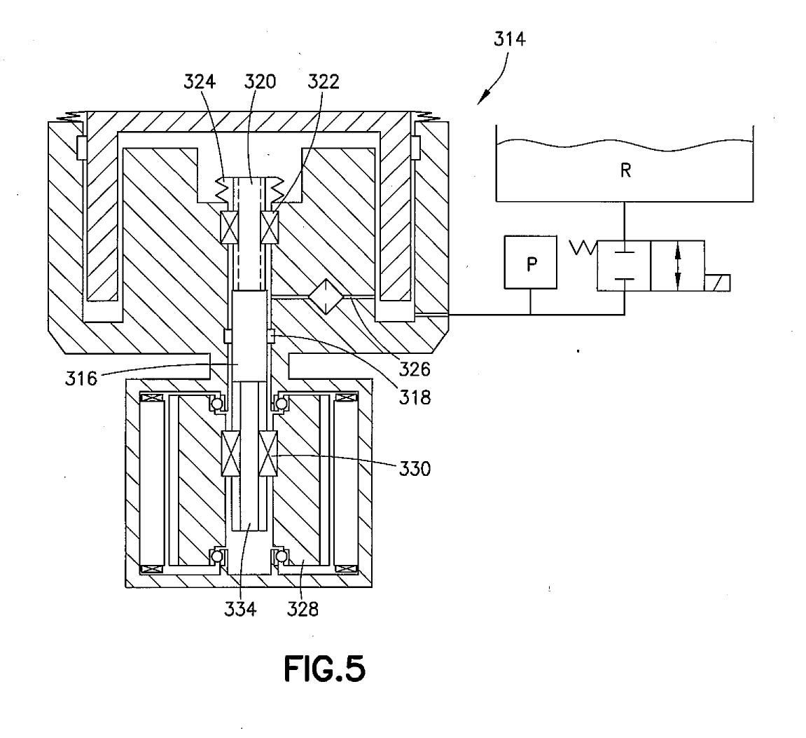

Referring now to FIG. 4, there is shown a section schematic view of electric-hydraulic actuator for a caliper 214. In this example, a translating and rotating working piston 216 is shown that rotates with the rotor 226 of the actuator. Here threaded portion 222 is threaded into mating portion 224 of housing 220 and coupled to working piston 216 that is sealed to housing 220 via seal 218. Rotor 226 has a spline portion 228 that is coupled to spline portion 230 that is coupled to and translates and rotates with working piston 216. In this example, threaded portion 222 is threaded in brake fluid where it alternately may be threaded on opposite side of the motor.

Referring now to FIG. 5, there is shown a section schematic view of electric-hydraulic actuator for a caliper 314. In this example, a translating (not rotating) working piston 316 is sealed to the caliper housing via seal 318. Rotor 328 has threaded portion 330 that drives thread 334 coupled to working piston 316. The caliper housing has spline portion 322 coupled to it that constrains spline 320 from rotating where spline 320 is coupled to working piston 316. Exclusion bellows 324 may be provided to exclude contaminants where the volume is provided with fluid via filter 326.

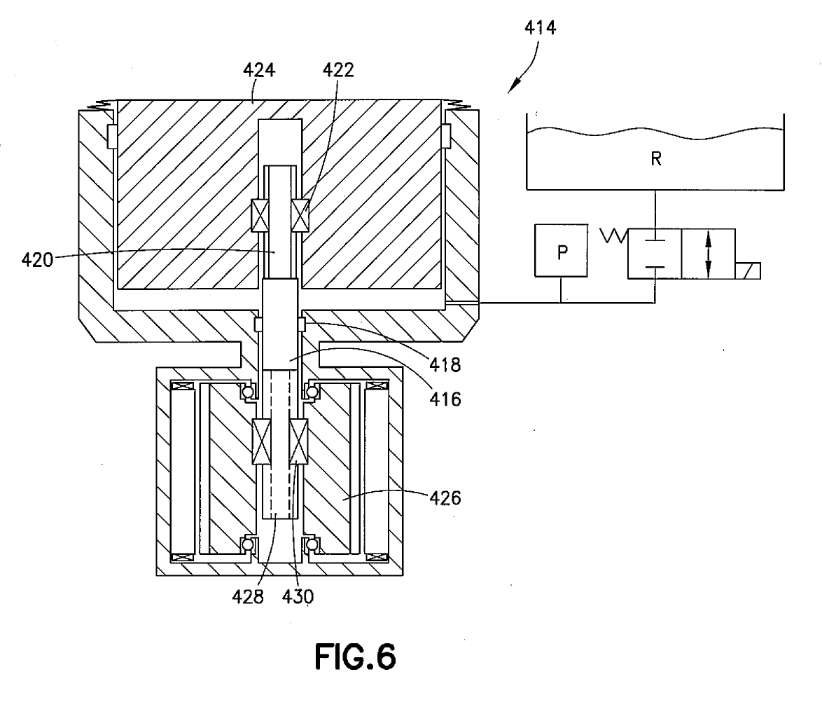

Referring now to FIG. 6, there is shown a section schematic view of electric-hydraulic actuator for a caliper 414. In this example, a translating (not rotating) working piston 416 is sealed to the caliper housing via seal 418. Rotor 426 has threaded portion 430 that drives thread 428 coupled to working piston 416. The lining piston 424 has spline portion 422 coupled to it that constrains spline 420 from rotating where spline 420 is coupled to working piston 416.

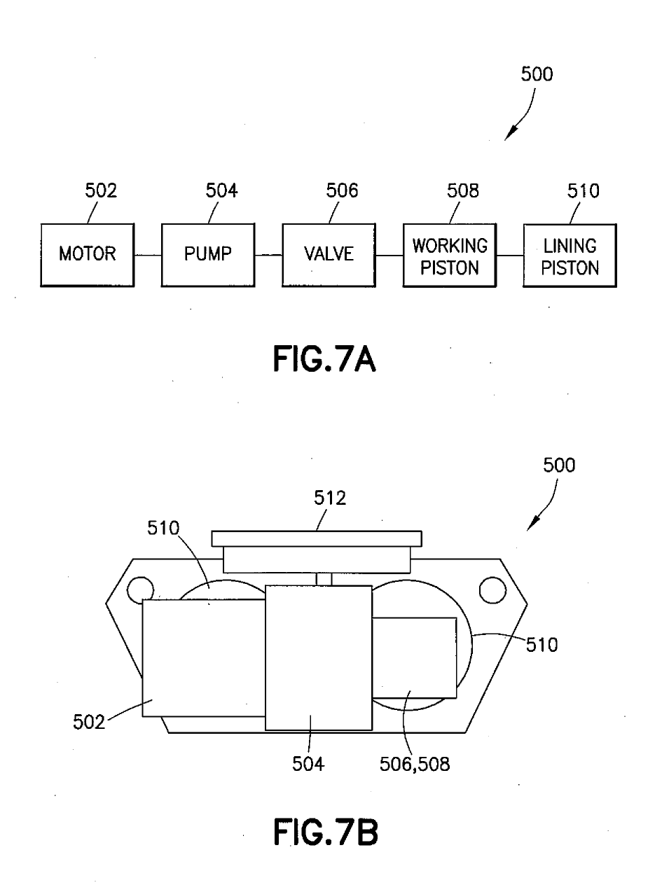

Referring now to FIG. 7A, there is shown a block diagram of hydraulic actuator 500. Referring also to FIG. 73, there is shown a side schematic view of electric-hydraulic actuator for a caliper 500. Caliper 500 has electric motor 502 and hydraulic pump 504 that selectively provide pressure to the lining cylinder 510 via hydraulic or brake fluid. Hydraulic pump 504 may be directly coupled to the lining cylinder 510 or may have a valve 506 and working piston 508 coupled there between. Reservoir 512 may be provided to replenish brake fluid as the linings wear. Pump 504 may be any suitable hydraulic pump. Motor 502 may be speed or torque controlled. Alternately motor 502 may run constant or any suitable speed and valve 506 may be provided to vary pressure, for example, via a proportional valve or otherwise. Pressure sensors, position feedback devices or other suitable devices (not shown) may be provided. The example shown has components of the system located locally at the caliper. Alternately, the components may be packaged otherwise. For example, a separate hydraulic pump may be provided with or without working piston or a local electric hydraulic pump may be with solenoid or servo valves.

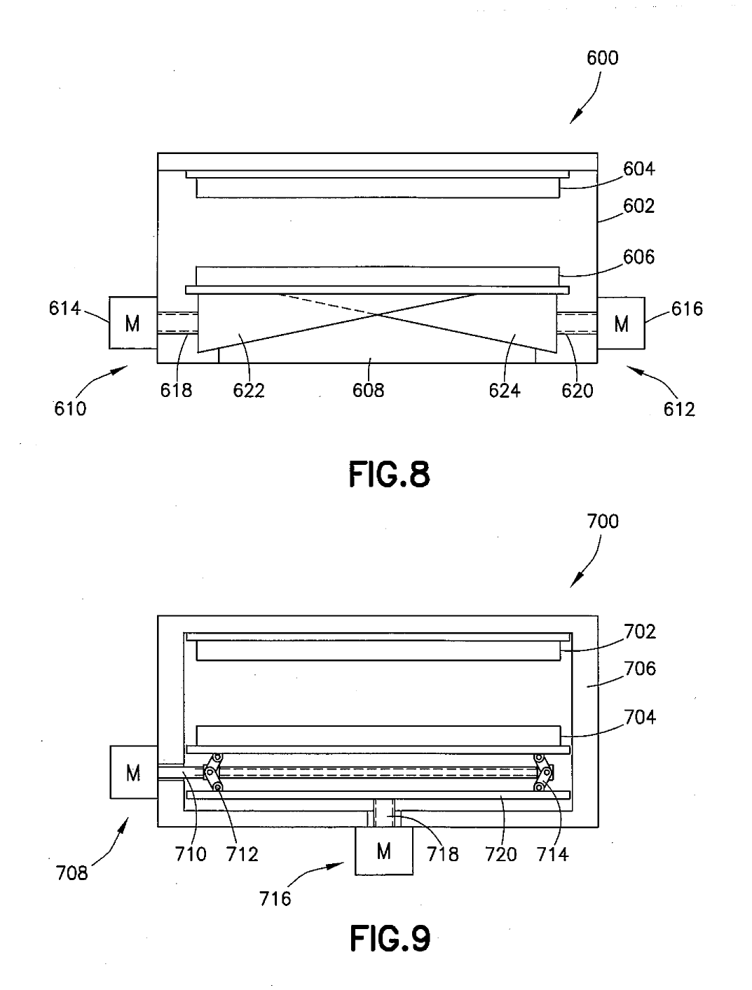

Referring now to FIG. 8, there is shown a schematic view of electric actuator for a caliper 600. Here, an example mechanical only non-hydraulic alternative is shown with interleaved opposing wedges and lead screw drives. Caliper 600 has housing 602 with linings 604, 606. Housing 602 has wedged portion 608 that interfaces with interleaved opposing wedges 622, 624 that are translated in opposite directions by motors 614, 616 driving screws 618, 620 respectively. The wedges are sized such that they have sufficient stroke to compensate for wear. In alternate aspects, a single motor may drive a screw with opposing threads to draw wedges 622, 624 together.

Referring now to FIG. 9, there is shown a schematic view of electric actuator for a caliper 700. Here, an example mechanical only non-hydraulic alternative is shown with a scissors jack type actuator in combination with a screw arrangement for lining wear and for use as a parking brake. Caliper 700 has housing 706 and linings 702, 704. Lining 704 is supported by scissors portions 712, 714 that are supported by translating portion 720. Motor 708 in combination with screw 710 actuate the scissors portions. Motor 716 in combination with screw 718 compensates for lining wear and may further act as a parking brake.

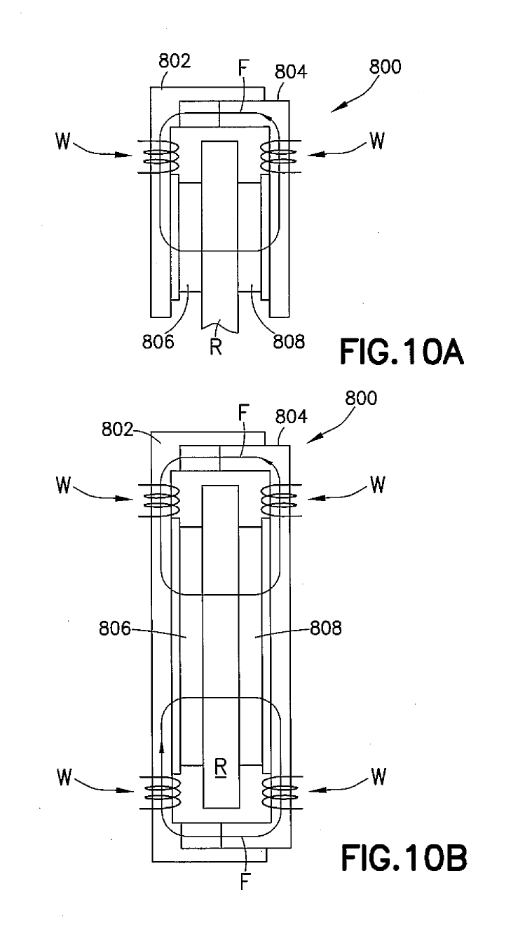

Referring now to FIGS. 10A and 10B, there is shown a schematic view of electro-magnetic actuator for a caliper 800 that brakes against rotor R. Caliper 800 has opposing housings 802, 804 and linings 806, 808 where windings W are energized to generate magnetic flux F that passes through rotor R, housings 802, 804 and linings 806, 808 to generate attractive forces to provide pressure between linings 806, 808 and rotor R. The housings 802, 804 and linings 806, 808 may be made of a suitable material, for example, ferrous material in whole or in part, that is conducive to conducting magnetic flux. The current in windings W may be selectively varied to generate varying amounts of force. A permanent magnet(s) may further be provided, for example rotated or switched in the form of an emergency or parking brake.

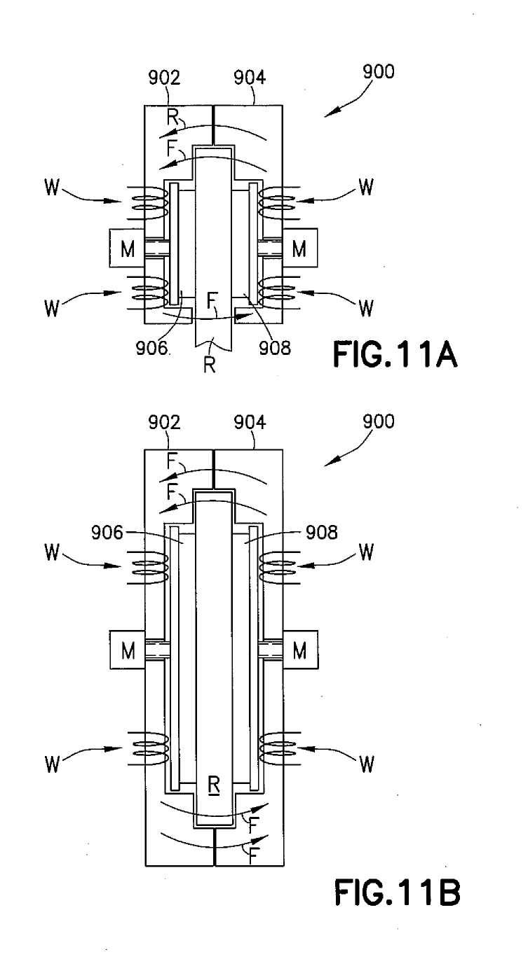

Referring now to FIGS. 11A and 11B, there is shown a schematic view of electro-magnetic actuator for a caliper 900 that brakes against rotor R. Caliper 900 has opposing housings 902, 904 and linings 906, 908 where windings W are energized to generate magnetic flux F that passes through rotor R and housings 902, 904 to generate attractive forces to provide pressure between linings 906, 908 and rotor R. The housings 902, 904 may be made of a suitable material, for example, ferrous material in whole or in part, that is conducive to conducting magnetic flux. The current in windings W may be selectively varied to generate varying amounts of force. A permanent magnet(s) may further be provided, for example rotated or switched in the form of an emergency or parking brake.

Further disclosed are alternate embodiments of a hybrid hydraulic electric brake calipers. The caliper may be such that a self-contained unit may be deployed at each wheel of a vehicle or device to be braked without the use of distributed hydraulics. Here, each brake may be controlled autonomously and independently. The embodiments may be provided with features alone or in combination with each other. Further, features as disclosed in United States Patent Application Publication US 2015/0136539 with a publication date of May 21, 2015; United States Patent Application Publication US 2015/0090540 with a publication date of Apr. 2, 2015; United States Patent Application Publication US 2014/0231189 with a publication date of Aug. 21, 2014; United States Patent Application Publication US 2013/0264154 with a publication date of Oct. 10, 2013; United States Patent Application Publication US 2011/0278107 with a publication date of Nov. 17, 2011 all of which are incorporated by reference herein may be provided alone or in combination with features disclosed. By way of example, features disclosed in the aforementioned patent publications may be utilized as a secondary or parking brake in combination with or as part of the calipers disclosed here in. By way of further example, features disclosed in the aforementioned patent publications such as gear trains or other power transmission components or otherwise may be utilized in place of components, for example, shafts or directly driven components of the calipers disclosed here in.

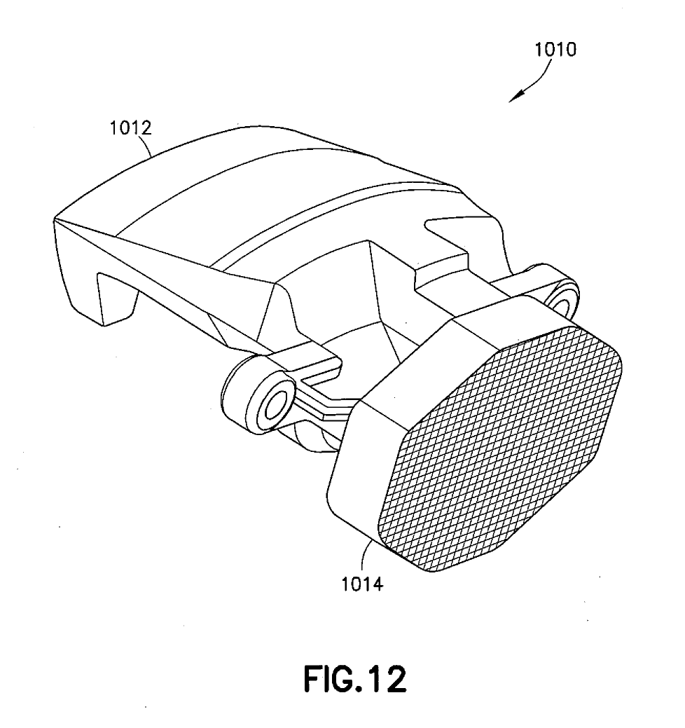

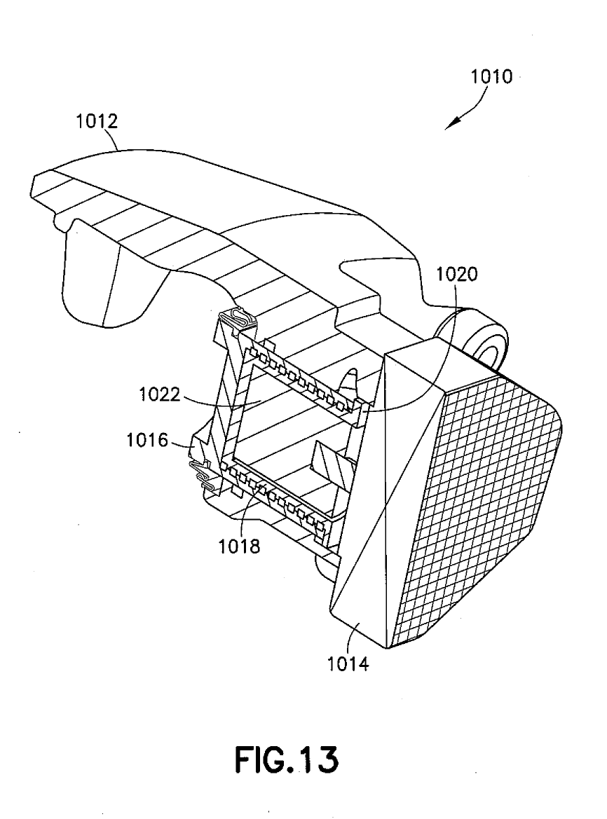

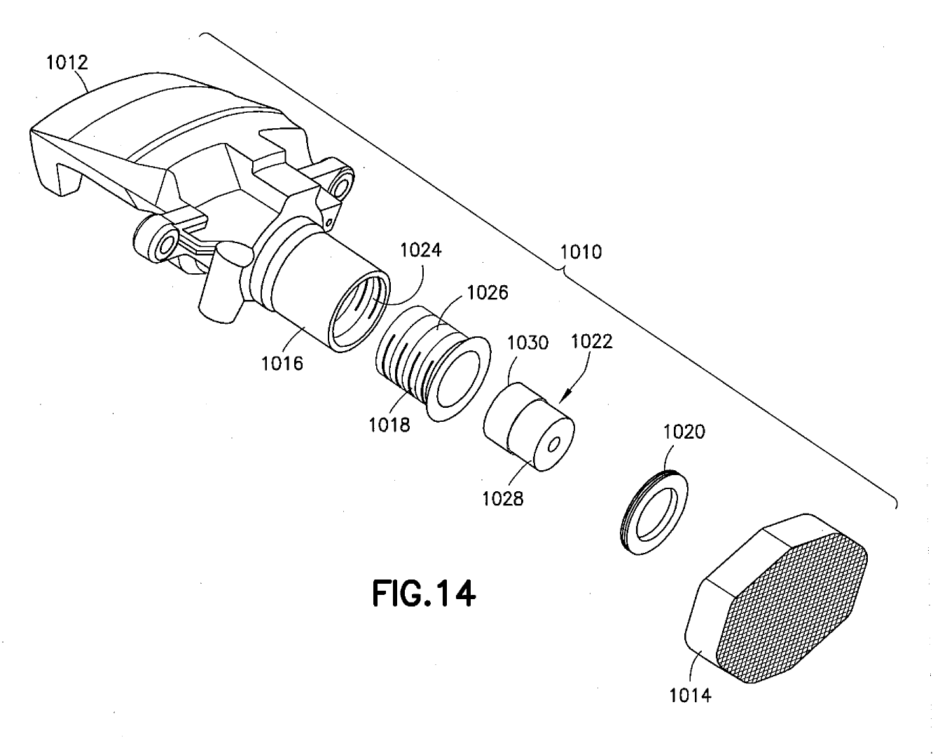

Referring to FIG. 12, there is shown an isometric view of caliper 1010. Referring also to FIG. 13, there is shown an isometric section view of caliper 1010. Referring also to FIG. 14, there is shown an isometric exploded view of caliper 1010. Caliper 1010 has housing 1012, motor 1014, lining cylinder 1016, screw 1018, transmission 1022, and thrust bearing 1020. Lining cylinder has inner threaded portion 1024 and screw 1018 has external threaded portion 1026. Here, the threaded portions engage with balls or otherwise acting as a screw or ball screw. Transmission 1022 has input portion 1028 and output portion 1030. Output portion 1030 is coupled to screw 1018 and input portion is driven by motor 1014. Transmission 1018 is nested within screw 18 and screw 1018 is nested within piston or nut 1016. Thrust bearing 1020 is coupled between screw 1018 and the housing of motor 1014. Caliper 1010 is shown having a single independently driven lining cylinder but alternately may have two or more for redundancy in the event of failure of one of them. Motor 1014 may be thermally isolated from caliper housing 1012 or lining piston 1016 with a thermal break. Position feedback (not shown) may be provided in any suitable manner for piston 1018, motor 1014 or other components. Similarly, current, temperature or other suitable monitoring may be provided for motor 1014. In alternate aspects, energy storage (e.g. capacitive) may be provided to cover the peak power requirement for the electromechanical solution. This may significantly reduce the peak current requirement. The stator of the motor 1014 may be a non-circular stator, for example, as disclosed in U.S. Provisional Patent Application No. 62/110,752 filed Feb. 2, 2015 and Ser. No. 15/011,802 filed Feb. 1, 2016 which are hereby incorporated by reference herein in their entireties. Alternatively, or additionally, the rotor may be non-circular or non-uniform. Thus, a non-uniform stator and/or rotor motor may be provided.

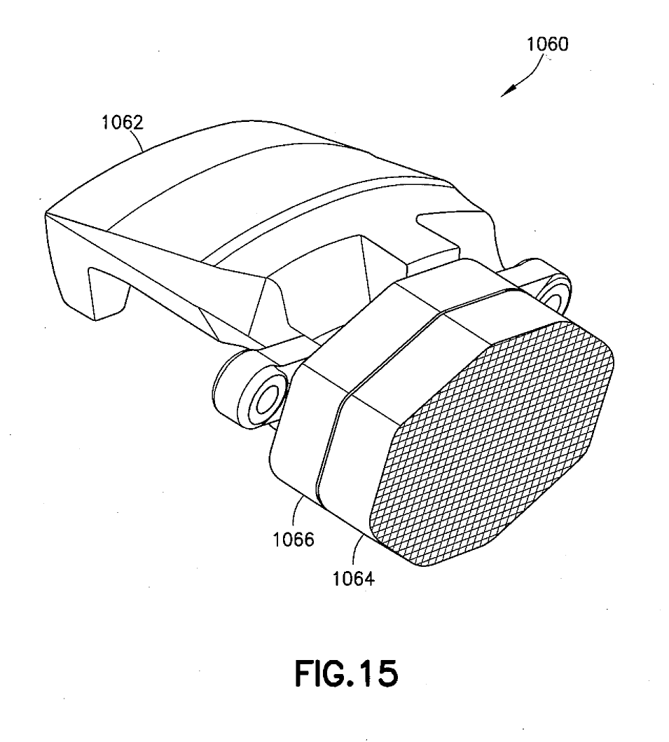

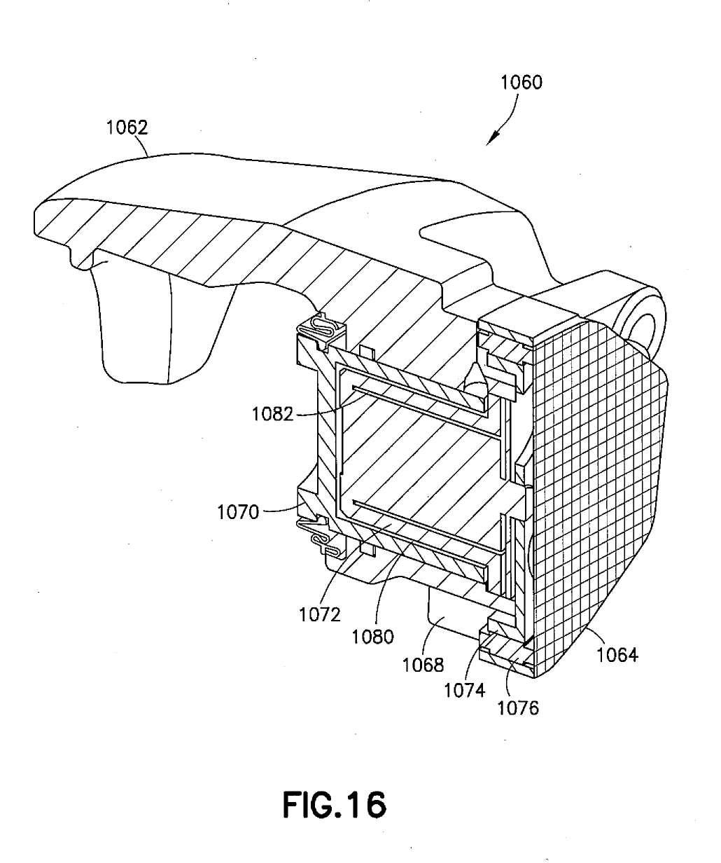

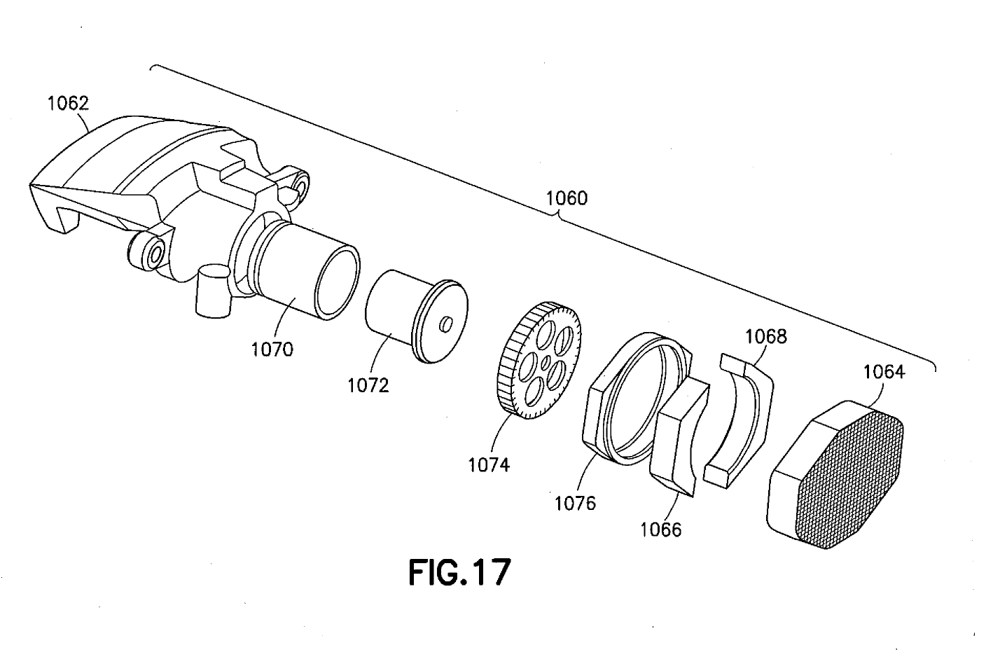

Referring now to FIG. 15, there is shown an isometric schematic view of electric—hydraulic actuator for a caliper 1060. Caliper 1060 provides for the use of an accumulator in a local electro-hydraulic system (lower peak power, fail-safe on loss of power). Referring also to FIG. 16, there is shown an isometric section view of caliper 1060. Referring also to FIG. 17, there is shown an isometric exploded view of caliper 1060. Caliper 1060 has caliper housing 1062, accumulator 1066, motor housing 1064, piston 1070, pump 1072, reservoir 1068, rotor 1074, stator 1076, high pressure volume 1080, low pressure volume 1082. The motor drives pump 1072 which in turn pumps brake fluid from the low pressure side to the high pressure side driving piston 1070. Accumulator 1066 is provided to supplement pump 1072. As the brake linings wear, reservoir 1068 provided additional brake fluid to supplement piston 1070. Here, actuator 1062 has a lining cylinder, electric actuator 1074, 1076, and reservoir 1068. The lining cylinder has lining piston 1070 in lining housing 1062, a seal and expansion seal, and pressurized fluid space 1080 in communication with the actuator. The electric actuator has pump 1072 in actuator cylinder housing 1062 and sealed across low and high pressure regions with the reservoir in communication with the low pressure region and the accumulator selectively in communication with the high pressure region. The pump is shown nested in the lining piston/cylinder. Position feedback may be provided, for example for the rotor or lining piston or otherwise.

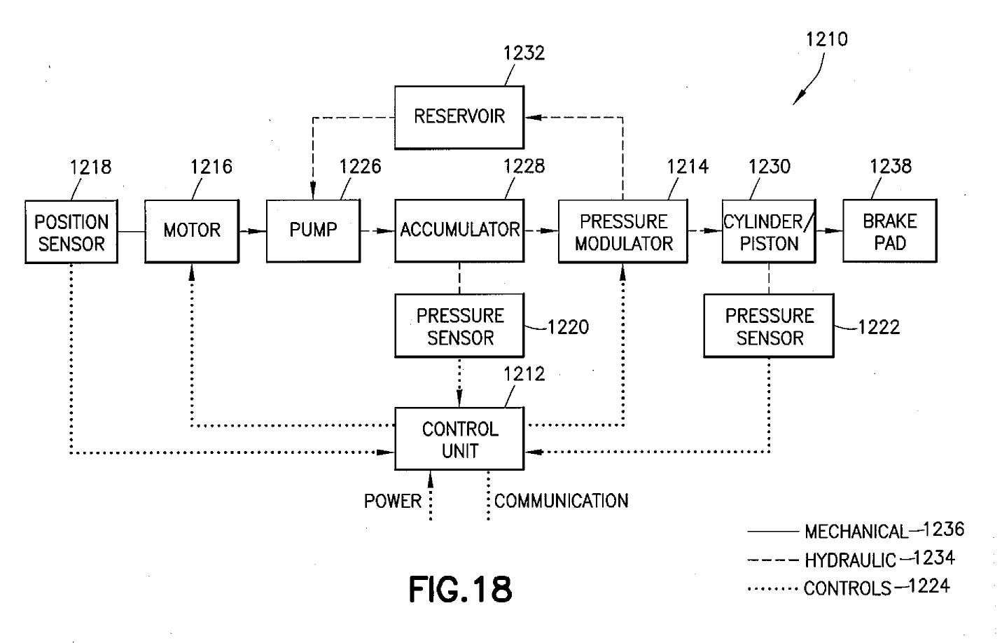

Referring now to FIG. 18, there is shown block diagram of electrohydraulic brake caliper 1210. Block diagram 1210 may apply to caliper 1060 or any suitable caliper or electrohydraulic caliper as disclosed or otherwise. System 1210 has control unit 1212 controlling pressure modulator 1214 (any suitable valve, proportional valve or other suitable pressure modulation device) and motor 1216. Feedback to controller 1212 is provided by position sensor 1218, pressure sensor 1220 and pressure sensor 1222 via electrical or control interface 1224. Motor 1216 drives pump 1226 which selectively provides hydraulic pressure to accumulator 1228 and cylinder/piston 1230 where reservoir 1232 provides hydraulic fluid via hydraulic lines 1234. Mechanical interfaces 1236 are provided to actuate brake pad 1238 against a rotor or otherwise.

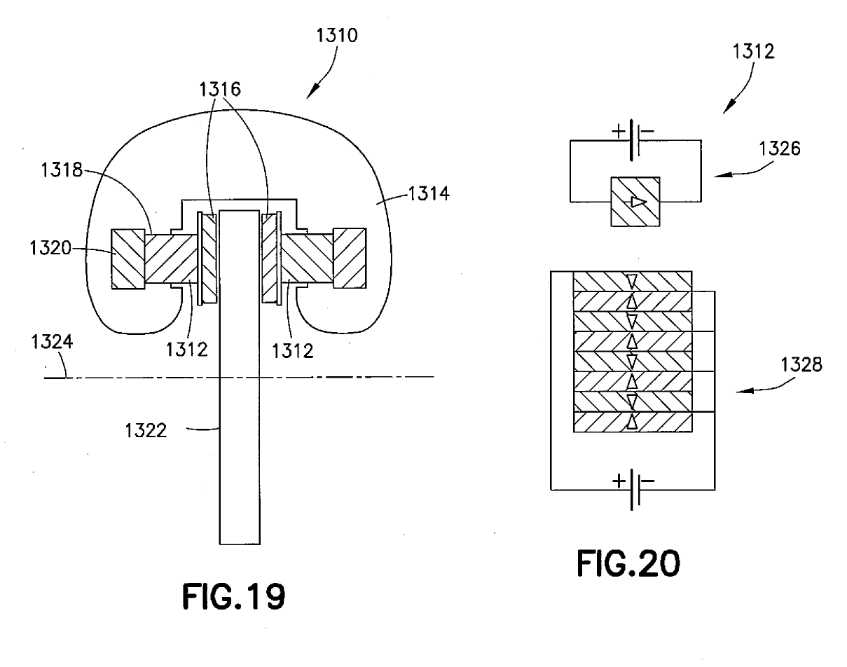

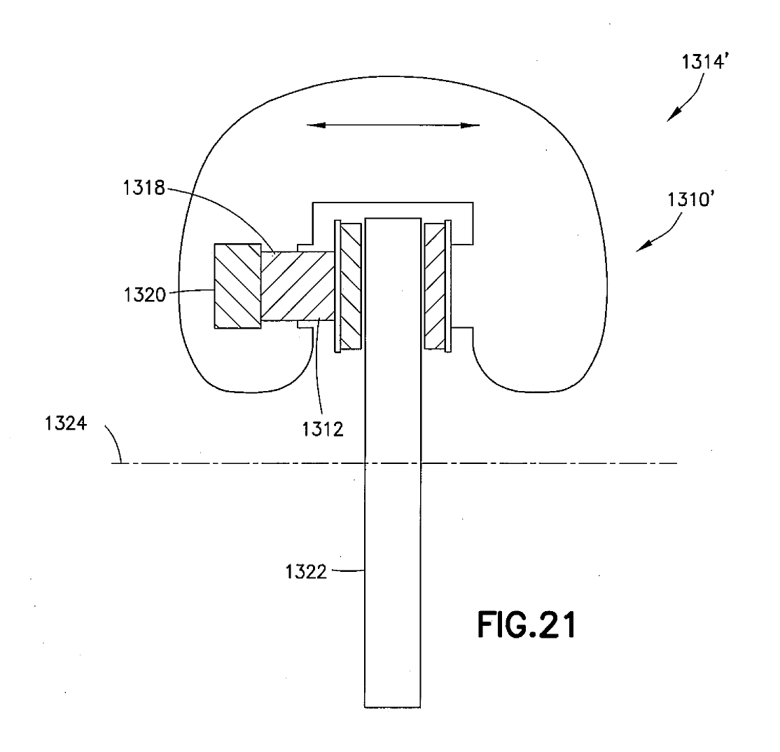

Referring now to FIG. 19, there is shown schematic diagram of brake system 1310. Referring also to FIG. 20, there is shown a schematic diagram of actuator 1312. Referring also to FIG. 21, there is shown a schematic diagram of caliper 1310′. Here, the embodiment shows a brake caliper with piezoelectric actuation. The brake caliper can be actuated by a combination of a fast acting piezo-electric component to supply the braking force, and a slow acting mechanism for taking up slack due to brake pad wear. Piezoelectric actuators can provide very large forces in small packages, with very high energy efficiency. Piezo-electric crystals can be stacked in series to provide more motion or in parallel for higher forces. In the embodiment shown, caliper housing 1314 may support two actuators whereas caliper housing 1314′ may support one actuator. Actuators 1312 provide pressure against pads 1316 acting on rotor 1322. A piezo actuator 1318 provides high pressure short throw actuation while wear actuator 1320 provides incremental motion to take up lining wear where actuator 1320 may be any suitable actuator. Disc 1322 is provided rotating on axis 1324. FIG. 20 shows exemplary single actuator 1326 or stacked actuator 1328 that may be provided with piezo elements either in parallel serial or a combination there of.

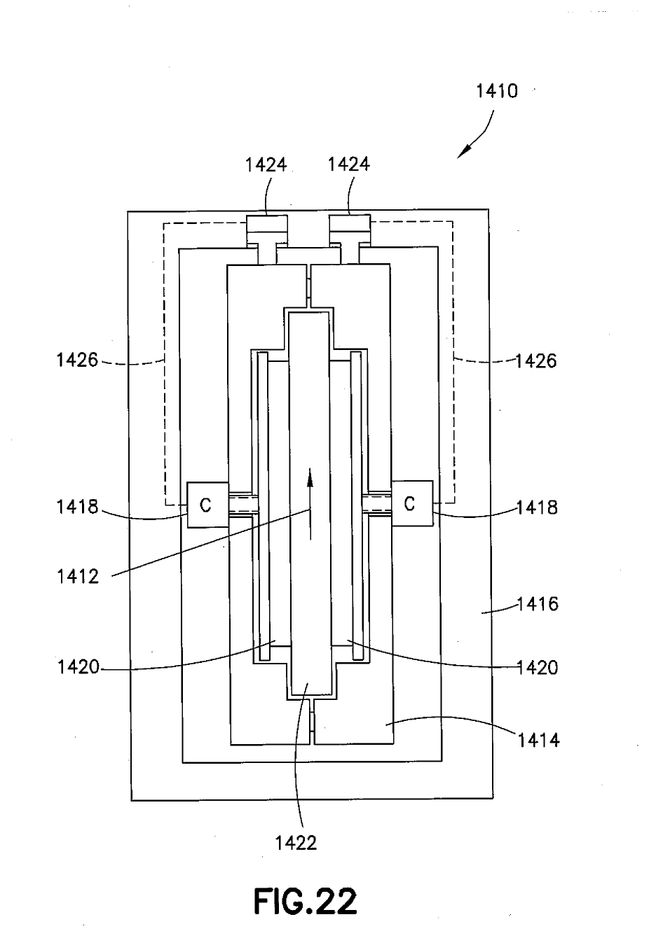

Referring now to FIG. 22, there is shown a schematic top view of brake system 1410. Brake system 1410 provides for an at least partially self-energizing design where tangential force from braking acts on plunger. In the embodiment shown, tangential force 1412 is reacted between primary caliper housing 1414 and secondary caliper housing 1416. Here, actuator 1418 acts on pads 1420 which in turn act on rotor 1422. Cylinder 1424 provided supplemental pressure coupled 1426 to actuator 1418 based on tangential force 1412 is reacted between primary caliper housing 1414 and secondary caliper housing 1416

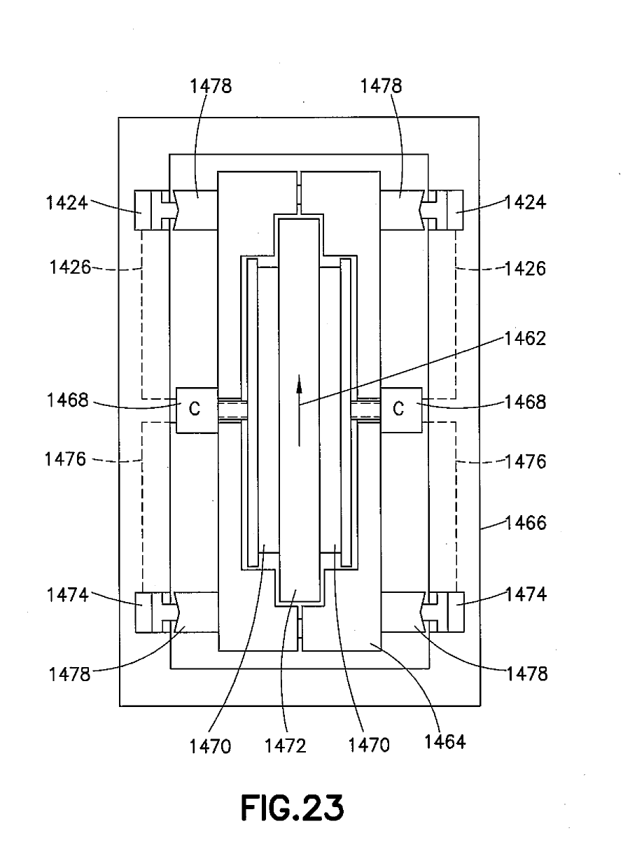

Referring now to FIG. 23, there is shown a schematic top view of brake system 1460. In the embodiment shown, tangential force 1462 is reacted between primary caliper housing 1464 and secondary caliper housing 1466 where actuator 1468 acts upon pads 1470 which in turn reacts on rotor 1472. Cylinder 1474 is provided coupled 1476 to actuator 1468 where relative movement between primary caliper housing 1464 and secondary caliper housing 1466 from tangential force 1462 acts (bi directionally) on wedges 1478 causing displacement of the pistons and providing supplemental pressure to actuator 1468 due to the tangential force 1462.

It should be understood that the foregoing description is only illustrative. Various alternatives and modifications can be devised by those skilled in the art. For example, features recited in the various embodiments could be combined with each other in any suitable combination(s). For example, position, pressure, current or other feedback may be provided on any suitable moving, actuating or actuated component. For example, further redundancy may be provided with respect to parking and emergency brakes or otherwise. For example, a secondary screw or spring mechanically released secondary working piston may be provided. In addition, features from different embodiments described above could be selectively combined into a new embodiment. Accordingly, the description is intended to embrace all such alternatives, modifications and variances.

Features as described herein may also be used with spray formed motor components such as described, for example, in U.S. patent application Ser. No. 14/988,814 filed Jan. 6, 2016 which is hereby incorporated by reference in its entirety. This may comprises spray deposition of a magnetic material. The magnetic material may comprise particles of an iron-containing material that, when deposited from a spray, results in an aggregate of small micro-domains separated by insulation boundaries. The electric motor assembly may comprise a composite housing having a core of sprayed magnetic particles and a winding on the core; and a rotor having a magnet located thereon, the rotor being rotatably mounted within the winding. The core of sprayed magnetic particles may comprise particles of an iron-containing material that when deposited results in an aggregate of small micro-domains separated by insulation boundaries. A method of fabricating a housing for a motor may comprise depositing a plurality of iron-containing particles on a substrate using a spray deposition technique to form a magnetic core; and machining at least one surface of the magnetic core to provide at least one surface for receiving a winding of the motor. Thus, the motor may comprise an at least partially spray formed motor component.

Features as described herein may include use of an electric motor in a brake caliper where the electric motor is a hybrid-field electric motor such as, for example, a hybrid-field electric motor as described in U.S. patent application Ser. No. 13/799,449 filed Mar. 13, 2013 and Ser. No. 14/501,668 filed Sep. 30, 2014 which are hereby incorporated by reference in their entireties.

The disclosed integrated electrohydraulic caliper as compared to an electromechanical caliper may exhibit isuperior dynamics (accumulated energy released extremely fast); lower peak power consumption (accumulator supplies pressurized fluid during peak demand); failsafe operation (accumulator stores energy locally); minimum increase of complexity in fixed and multi-piston caliper configurations, which may be more difficult to realize electromechanically.

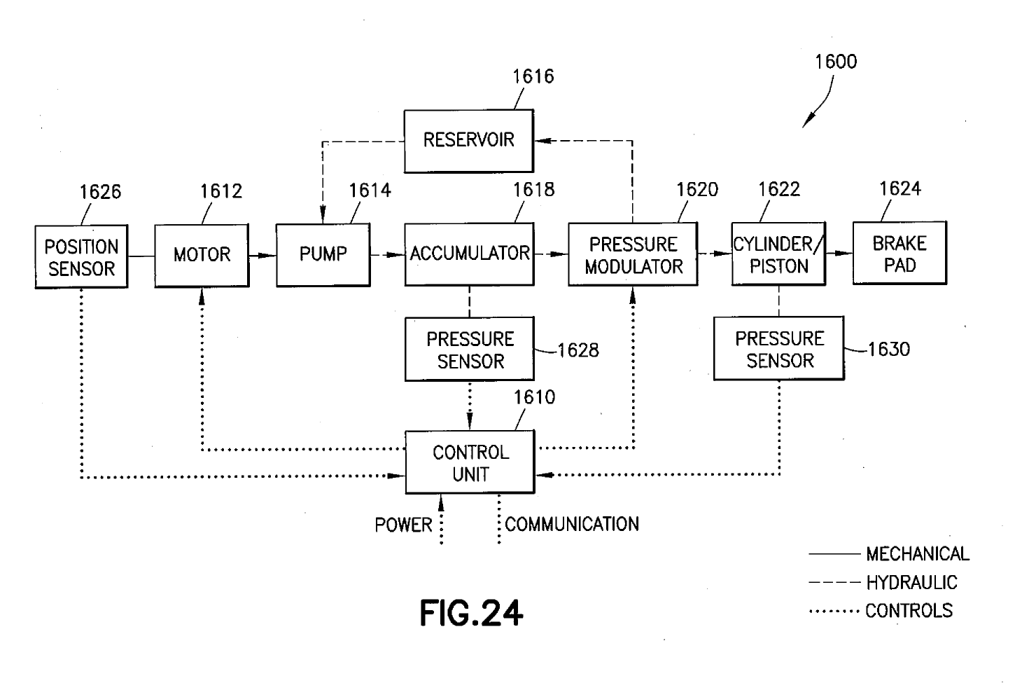

In FIG. 24 a schematic block diagram of a single-piston sliding caliper 1600 is shown. Caliper 1600 has control unit 1610 that is supplied with power and communication interfaces. Control unit 1610 controls motor 1612 which in turn drives pump 1614 where pump 1614 draws hydraulic fluid from reservoir 1616 and pressurizes accumulator 1618. Control unit 1610 further controls pressure modulator 1620 which in turn selectively provides pressurized hydraulic fluid from accumulator 1618 to cylinder piston 1622. Cylinder piston 1622 in turn applies force to brake pad 1624 to engage a rotor for braking action. Feedback to controller 1610 may be from position sensor 1626 coupled to motor 1612, pressure sensor 1628 in communication with accumulator 1618 and pressure sensor 1630 in communication with cylinder piston 1622. In alternate aspects, more or less sensors may be provided for example, cylinder position, force feedback or otherwise. The caliper body is coupled to its support so that it can move in the lateral direction. The caliper has a single cylinder/piston, which is configured to press one of the brake pads against the brake disk. The other brake pad is attached to the caliper body. When hydraulic pressure is applied, the hydraulic fluid pushes the piston out of the cylinder, forcing one of the brake pads against the brake disk. At the same time, the hydraulic fluid forces the caliper to slide in the opposite direction, pressing the other brake pad against the opposite surface of the brake disk.

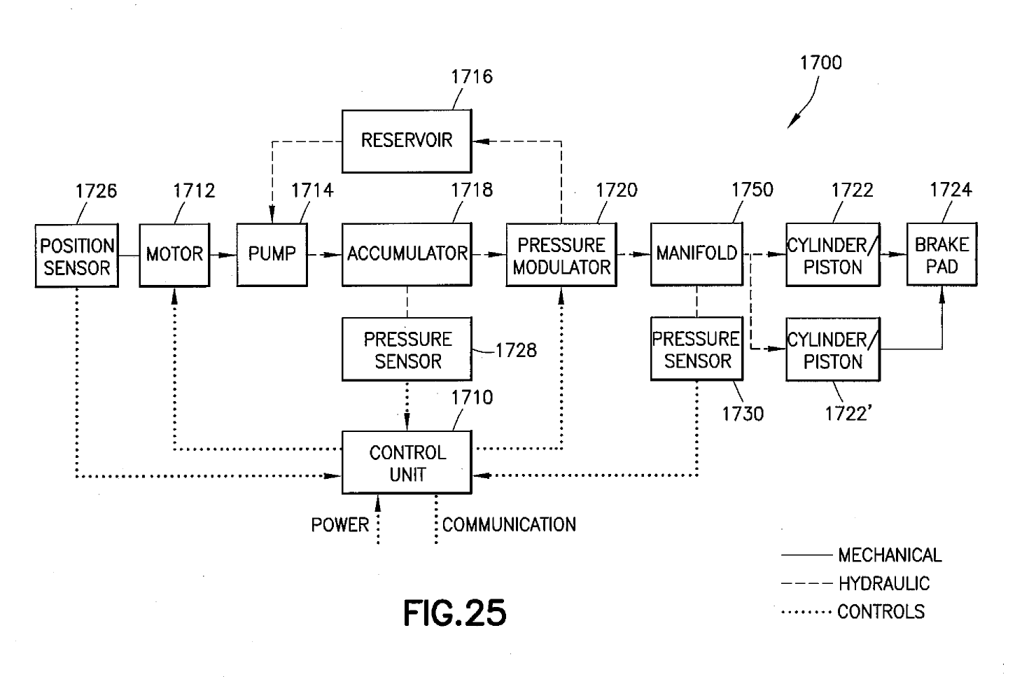

In FIG. 25 a schematic block diagram of a multi-piston sliding caliper 1700 is shown. Caliper 1700 has control unit 1710 that is supplied with power and communication interfaces. Control unit 1710 controls motor 1712 which in turn drives pump 1714 where pump 1714 draws hydraulic fluid from reservoir 1716 and pressurizes accumulator 1718. Control unit 1710 further controls pressure modulator 1720 which in turn selectively provides pressurized hydraulic fluid from accumulator 1718 to multiple cylinder pistons 1722, 1722′ via a control manifold 1750. Cylinder pistons 1722, 1722′ in turn apply force to brake pad 1724 to engage a rotor for braking action. Feedback to controller 1710 may be from position sensor 1726 coupled to motor 1712, pressure sensor 1728 in communication with accumulator 1718 and one or more pressure sensors 1730 in communication with the control manifold 1750. In alternate aspects, more or less sensors may be provided for example, cylinder position, force feedback or otherwise. The caliper body is coupled to its support so that it can move in the lateral direction. The caliper has a plurality of cylinders/pistons, which are configured to press one of the brake pads against the brake disk. The other brake pad is attached to the caliper body. When hydraulic pressure is applied, the hydraulic fluid pushes the pistons out of the cylinders, forcing one of the brake pads against the brake disk. At the same time, the hydraulic fluid forces the caliper to slide in the opposite direction, pressing the other brake pad against the opposite surface of the brake disk. An example of a two-piston caliper is illustrated in the figure, but more than two may be provided.

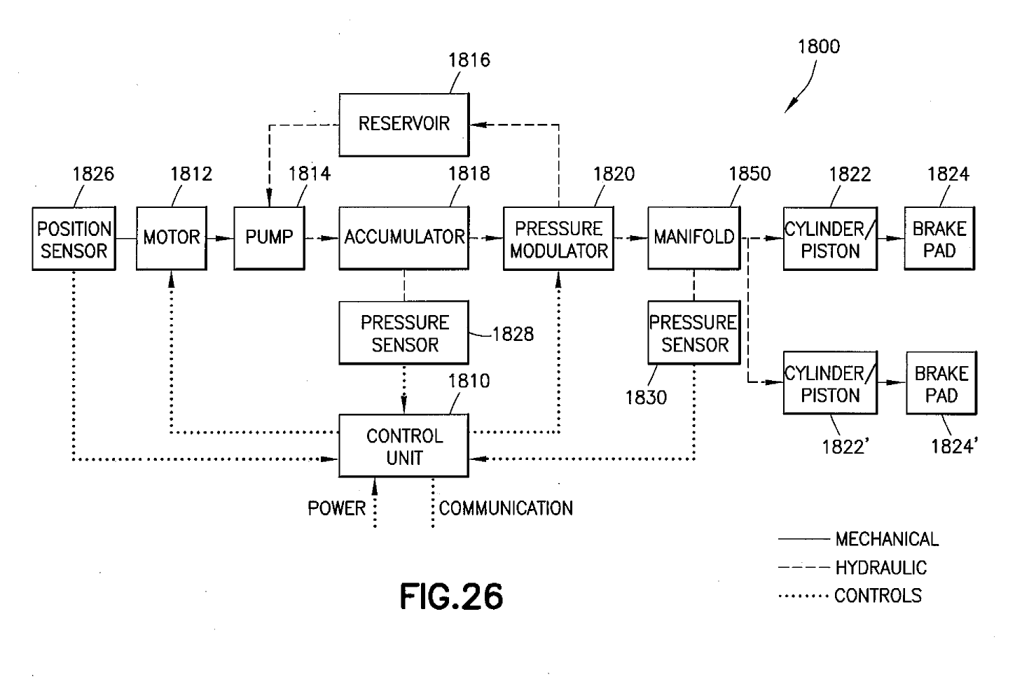

In FIG. 26 a schematic block diagram of a two-piston fixed caliper 1800 is shown. Caliper 1800 has control unit 1810 that is supplied with power and communication interfaces. Control unit 1810 controls motor 1812 which in turn drives pump 1814 where pump 1814 draws hydraulic fluid from reservoir 1816 and pressurizes accumulator 1818. Control unit 1810 further controls pressure modulator 1820 which in turn selectively provides pressurized hydraulic fluid from accumulator 1818 to multiple opposing cylinder/pistons 1822, 1822′ via the manifold 1850. Cylinder/pistons 1822, 1822′ in turn apply force to brake pads 1824, 1824′ to engage a rotor for braking action. Feedback to controller 1810 may be from position sensor 1826 coupled to motor 1812, pressure sensor 1828 in communication with accumulator 1818 and one or more pressure sensors 1830 in communication with the manifold 1850 and/or cylinder/pistons 1822, 1822′. In alternate aspects, more or less sensors may be provided for example, cylinder position, force feedback or otherwise. The caliper body is attached to its support and does not move when hydraulic pressure is applied. The caliper has an inner cylinder/piston on the inboard side, which is configured to press an inner brake pad against the inner surface of the brake disk, and an outer cylinder/piston on the outboard side, which is configured to press the outer brake pad against the outer surface of the brake disk.

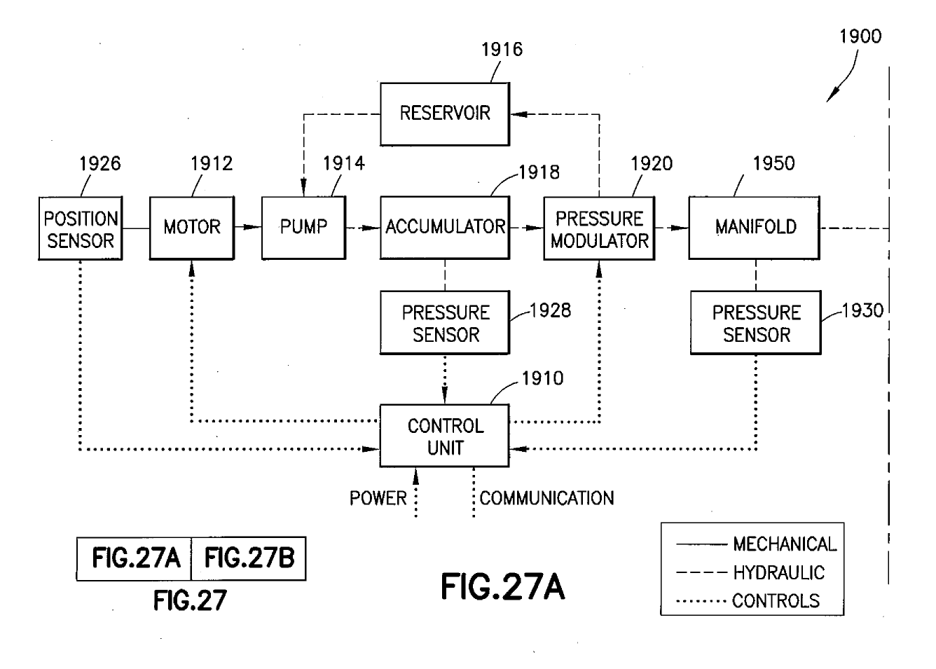

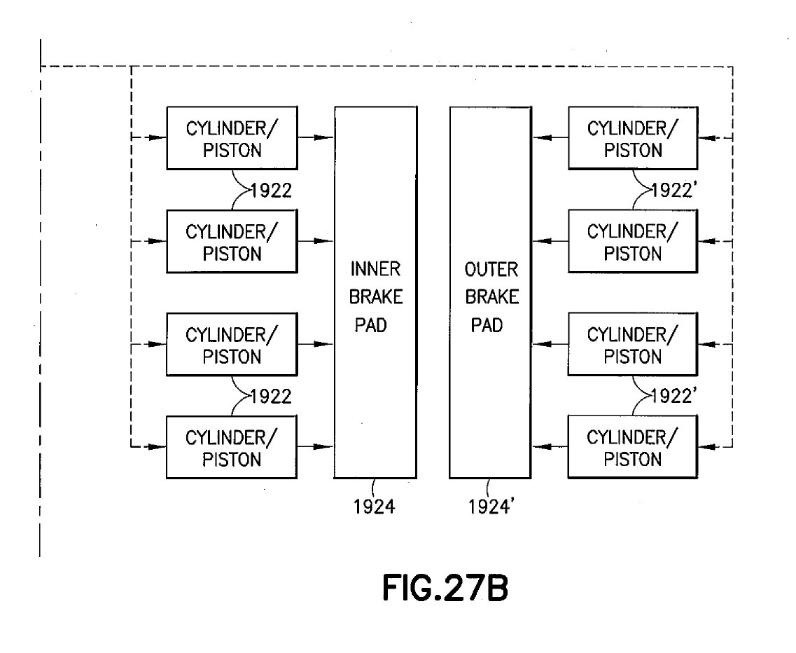

In FIG. 27 a schematic block diagram of a multi-piston fixed caliper 1900 is shown. Caliper 1900 has control unit 1910 that is supplied with power and communication interfaces. Control unit 1910 controls motor 1912 which in turn drives pump 1914 where pump 1914 draws hydraulic fluid from reservoir 1916 and pressurizes accumulator 1918. Control unit 1910 further controls pressure modulator 1920 which in turn selectively provides pressurized hydraulic fluid from accumulator 1918 to multiple opposing cylinder/pistons 1922, 1922′ via the manifold 1950. In this example embodiment four cylinder/pistons are shown. However, alternately, more or less may be provided. Cylinder/pistons 1922, 1922′ in turn apply force to brake pads 1924, 1924′ to engage a rotor for braking action. Feedback to controller 1910 may be from position sensor 1926 coupled to motor 1912, pressure sensor 1928 in communication with accumulator 1918 and one or more pressure sensors 1930 in communication with the manifold 1950 and/or the cylinder/pistons 1922 and/or 1922′. In alternate aspects, more or less sensors may be provided such as, for example, cylinder or brake pad position, force feedback or otherwise. The caliper body is attached to its support and does not move when hydraulic pressure is applied. The caliper has a plurality of inner cylinders/pistons on the onboard side and a plurality of outer cylinders/pistons on the outboard side. An example of an eight-piston caliper is illustrated in the figure.

An example embodiment may be provided in an apparatus comprising a brake caliper comprising a housing and a hydraulic actuator connected to the housing, where the hydraulic actuator comprises a hydraulic cylinder at least partially formed by the housing, a lining piston movably mounted with the hydraulic cylinder, and an electric actuator, where the electric actuator comprises an electric motor and a working piston, where the electric actuator is configured to move the working piston such that the working piston pushes against the hydraulic fluid in the hydraulic actuator.

The electric motor may comprise a linear motor, where the linear motor comprises a stator and a linearly magnetically driven member, where the driven member is connected to the working piston to linearly move the working piston based upon linear movement of the driven member by the stator. The electric motor may comprise a stator and a rotor, where the rotor is connected to the working piston to linearly move the working piston based upon axial rotation of the rotor by the stator. A threaded shaft may extends from the rotor and is connected to a threaded portion of the working piston such that the working piston is configured to longitudinally move on the threaded shaft as the threaded shaft is axially rotated relative to the working piston. A connection may be provided between the working piston and a frame member of the hydraulic cylinder to prevent the working piston from rotating relative to the frame member. The electric motor may comprise a stator and a rotor, where the rotor is connected to the working piston to axially rotate the working piston based upon axial rotation of the rotor by the stator, where the working piston is connected to another member such that axial rotation of the working piston results in linear movement of the working piston relative to the another member. A connection may be provided between the working piston and a frame member of the hydraulic cylinder to allow only translational movement of the working piston relative to the frame member. The apparatus may further comprise an exclusion bellows located between the working piston and a frame member of the hydraulic cylinder. The electric motor may comprise a non-circular stator and/or a non-uniform rotor. The electric motor may comprise at least one spray formed motor component. The electric motor may comprise a hybrid-field motor. The hydraulic actuator may comprise a frame member forming at least a portion of a hydraulic fluid receiving area, where the electric actuator is located, at least partially, in the frame member. The apparatus may further comprise a piezoelectric member connected to the housing and configured to at least partially move the lining piston or the working piston. The apparatus may further comprise a system for using tangential force on a brake disc from a braking action of brake caliper on the brake disc to increase hydraulic force in the hydraulic cylinder.

An example embodiment may be provide in an apparatus comprising a brake caliper comprising a housing; a hydraulic actuator connected to the housing, where the hydraulic actuator comprises a hydraulic cylinder connected to the housing, a lining piston movably mounted with the hydraulic cylinder, and an electric actuator, where the electric actuator comprises an electric motor and a working piston, where the motor comprises a stator and a rotor, where the working piston is connected to the rotor to push against the hydraulic fluid in the hydraulic actuator based upon the rotor being rotated by the stator.

A threaded shaft may extend from the rotor and be connected to a threaded portion of the working piston such that the working piston is configured to longitudinally move on the threaded shaft as the threaded shaft is axially rotated relative to the working piston. A connection may be provided between the working piston and a frame member of the hydraulic cylinder to prevent the working piston from rotating relative to the frame member. A connection may be provided between the working piston and a frame member of the hydraulic cylinder to allow only translational movement of the working piston relative to the frame member. The apparatus may further comprise an exclusion bellows located between the working piston and a frame member of the hydraulic cylinder. The electric motor may comprise a non-circular stator and/or a non-uniform rotor. The electric motor may comprise at least one spray formed motor component. The electric motor may comprise a hybrid-field motor. The hydraulic actuator may comprise a frame member forming at least a portion of a hydraulic fluid receiving area, where the electric actuator is located, at least partially, in the frame member.

An example embodiment may be provided in a brake caliper comprising a housing; opposing brake linings; a brake lining drive connected to the housing, where the brake lining drive comprises an electric motor and rotatable screw shaft extending from the electric motor; and a mechanical connection of the rotatable screw shaft to at least one of the opposing brake linings, where the mechanical connection is configured to linearly move the at least one opposing brake lining based upon axial rotation of the rotatable screw shaft by the electric motor.

The brake lining drive may comprise a wedge portion and at least one wedge slidingly located on the wedge portion, where the at least one wedge has the at least one opposing brake lining thereon, where the rotatable screw shaft is connected to the at least one wedge to slide the at least one wedge against the wedge portion in a first direct as the rotatable screw shaft is axially rotated and thereby move the at least one wedge and the at least one opposing brake lining in a second different direction. The mechanical connection may comprise scissor portions connected to the rotatable screw shaft which are configured to expand and contract as the rotatable screw shaft is axially rotated.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

What is claimed is:

1. A brake caliper comprising:
a housing; and
a hydraulic actuator connected to the housing, where the hydraulic actuator comprises a hydraulic cylinder formed at least partially by the housing, a lining piston movably mounted with the hydraulic cylinder, and an electric actuator, where the electric actuator comprises an electric motor and a working piston, where the electric actuator is at least partially located in the housing,
where the electric actuator is configured to move the working piston such that the working piston pushes against the hydraulic fluid in the hydraulic actuator.

2. A brake caliper as in claim 1 where the electric motor comprises a linear motor, where the linear motor comprises a stator and a linearly magnetically driven member, where the driven member is connected to the working piston to linearly move the working piston based upon linear movement of the driven member by the stator.

3. A brake caliper as in claim 1 where the electric motor comprises a stator and a rotor, where the rotor is connected to the working piston to linearly move the working piston based upon axial rotation of the rotor by the stator.

4. A brake caliper as in claim 3 where a threaded shaft extends from the rotor and is connected to a threaded portion of the working piston such that the working piston is configured to longitudinally move on the threaded shaft as the threaded shaft is axially rotated relative to the working piston.

5. A brake caliper as in claim 4 where a connection is provide between the working piston and the housing to prevent the working piston from rotating relative to the housing.

6. A brake caliper as in claim 1 where the electric motor comprises a stator and a rotor, where the rotor is connected to the working piston to axially rotate the working piston based upon axial rotation of the rotor by the stator, where the working piston is connected to the housing such that axial rotation of the working piston results in linear movement of the working piston relative to the housing.

7. A brake caliper as in claim 1 where a connection is provide between the working piston and the housing to allow only translational movement of the working piston relative to the housing.

8. A brake caliper as in claim 1 further comprising an exclusion bellows located between the working piston and the housing.

9. A brake caliper as in claim 1 where the electric motor comprises a non-circular stator and/or a non-uniform rotor.

10. A brake caliper as in claim 1 where the electric motor comprises at least one spray formed motor component.

11. A brake caliper as in claim 1 where the electric motor comprises a hybrid-field motor.

12. A brake caliper as in claim 1 where the hydraulic actuator comprises a frame member forming at least a portion of a hydraulic fluid receiving area, where the electric actuator is located, at least partially, in the frame member.

13. A brake caliper as in claim 1 further comprising a piezoelectric member connected to the housing and configured to at least partially move the lining piston or the working piston.

14. A brake caliper as in claim 1 further comprising a system for using tangential force on a brake disc from a braking action of brake caliper on the brake disc to increase hydraulic force in the hydraulic cylinder.

15. A brake caliper comprising:
a housing; and
a hydraulic actuator connected to the housing, where the hydraulic actuator comprises a hydraulic cylinder at least partially formed by the housing, a lining piston movably mounted with the hydraulic cylinder, and an electric actuator, where the electric actuator comprises an electric motor and a working piston, where the motor comprises a stator and a rotor, where the working piston is connected to the rotor to push against the hydraulic fluid in the housing based upon the rotor being rotated by the stator.

16. A brake caliper as in claim 15 where a threaded shaft extends from the rotor and is connected to a threaded portion of the working piston such that the working piston is configured to longitudinally move on the threaded shaft as the threaded shaft is axially rotated relative to the working piston.

17. A brake caliper as in claim 15 where a connection is provide between the working piston and the housing to prevent the working piston from rotating relative to the housing.

18. A brake caliper as in claim 15 where a connection is provide between the working piston and the housing to allow only translational movement of the working piston relative to the housing.

19. A brake caliper as in claim 15 further comprising an exclusion bellows located between the working piston and a frame member of the hydraulic cylinder.

20. A brake caliper as in claim 15 where the electric motor comprises a non-circular stator and/or a non-uniform rotor.

21. A brake caliper as in claim 15 where the electric motor comprises at least one spray formed motor component.

22. A brake caliper as in claim 15 where the electric motor comprises a hybrid-field motor.

23. A brake caliper as in claim 15 where the housing comprises a frame member forming at least a portion of a hydraulic fluid receiving area, where the electric actuator is located, at least partially, in the frame member.

24. A brake caliper comprising:
a housing;
opposing brake linings;
a brake lining drive connected to the housing, where the brake lining drive comprises an electric motor and a rotatable screw shaft extending from the electric motor; and
a mechanical connection of the rotatable screw shaft to at least one of the opposing brake linings, where the mechanical connection is configured to linearly move the at least one opposing brake lining based upon axial rotation of the rotatable screw shaft by the electric motor.

25. A brake caliper as in claim 24 where the brake lining drive comprises a wedge portion and at least one wedge slidingly located on the wedge portion, where the at least one wedge has the at least one opposing brake lining thereon, where the rotatable screw shaft is connected to the at least one wedge to slide the at least one wedge against the wedge portion in a first direct as the rotatable screw shaft is axially rotated and thereby move the at least one wedge and the at least one opposing brake lining in a second different direction.

26. A brake caliper as in claim 24 where the mechanical connection comprises scissor portions connected to the rotatable screw shaft which are configured to expand and contract as the rotatable screw shaft is axially rotated.
